(19) United States
(12) Patent Application Publication
(10) Pub. No.: US 2014/0205392 A1
(43) Pub. Date: Jul. 24, 2014

(54) CARGO DEPLOYMENT SYSTEM

(71) Applicant: GM GLOBAL TECHNOLOGY OPERATIONS LLC, Detroit, MI (US)

(72) Inventor: Chet Wisniewski, Royal Oak, MI (US)

(73) Assignee: GM Global Technology Operations LLC, Detroit, MI (US)

(21) Appl. No.: 13/757,278

(22) Filed: Feb. 1, 2013

Related U.S. Application Data
(63) Continuation-in-part of application No. 13/746,586, filed on Jan. 22, 2013.

(51) Int. Cl. B60P 1/64

(52) U.S. Cl. CPC B60P 1/6418
USPC 410/66; 410/52

(57) ABSTRACT

A number of variation may include a vehicle construction and cargo deployment system in which the vehicle suspends pre-packaged modules from above (instead of supported from below). This aids rapid deployment in thoroughfare environments. Concept may include at least one module for containment and delivery of cargo to a location, which may also include a vehicle for thoroughfare delivery of the module which may also include an edge at or within the height of a curb on a thoroughfare for deployment of the module onto the curb.

### CROSS-REFERENCE TO RELATED APPLICATIONS

This application is a continuation-in-part of U.S. patent application Ser. No. 13/746,586 filed on Jan. 22, 2013 and this application claims the benefit of the filing date thereof.

### TECHNICAL FIELD

The field to which the disclosure generally relates to includes orientations of carrier vehicles and systems, methods, and products used to deploy and deliver cargo in carrier vehicles.

### BACKGROUND

A cargo deployment system may have a plurality of modules to deploy a cargo from a first location to a second location for delivery. The cargo may be deployed via a vehicle to move the cargo from a first location to a second location with increased speed. The cargo may be deployed from the vehicle at thoroughfare locations in congested cities.

### SUMMARY OF ILLUSTRATIVE VARIATIONS OF THE INVENTION

One variation may include a system for deployment of cargo which may include at least one module for containment and delivery of cargo to a location and a vehicle for thoroughfare delivery of the module. The vehicle orientation is such that the vehicle arrangement enables modules to be suspended. The structure of this vehicle further eliminates or minimizes a supportive floor when in transit. A small ledge may be provided along the center of the vehicle to aid in receiving module corner (detail 48) and securing onto vehicle.

Another variation may include a product which may include a cargo delivery system which may include a vehicle wherein the vehicle may include an edge at or within 2 inches of the height of a curb on a thoroughfare.

Another variation may include method which may include loading at least one module for delivery to the location into a vehicle through an edge on the side of a vehicle that is at or within 2 inches of the height of a curb on a thoroughfare; moving the vehicle closer to the location; un-loading the module from the vehicle through the edge on the side of the vehicle that is at or within 2 inches of the height of a curb on a thoroughfare; and delivering the module to the location.

Other illustrative variations of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations of the invention will become more fully understood from the detailed description and the accompanying drawings, wherein:

FIG. 1 is a perspective view of one variation of a cargo deployment system.

FIG. 2 is an enlarged longitudinal view of a vehicle, showing one variation of a product.

FIG. 3 is an enlarged side view of a vehicle, showing one variation of a product.

FIG. 4 is a perspective view of one variation of a cargo deployment system.

FIG. 5 is a cross-section of a vehicle, showing one variation of a product.

FIG. 6 is an enlarged view of a vehicle and a module, showing one variation of a product.

### DETAILED DESCRIPTION OF ILLUSTRATIVE VARIATIONS OF THE INVENTION

The following description of the variations is merely illustrative in nature and is in no way intended to limit the invention, its application, or uses.

The figures illustrate a number of variations of a cargo deployment system 10, which may ease existing issues of traffic congestion, parking (and associated penalties), weight, mobility, speed, and integration within a densely populated urban area. The cargo deployment system 10, may be used to deliver a variety of cargo types including, but not limited to, mail, emergency supplies, munitions, goods, produce, bulk cargo, project cargo, or may be another type. The cargo deployment system 10 may also, among other things, be updated, implemented, or modified to support/suspend cargo and protect it from the elements through the use of a vehicle 12, module 14, and edge 16. Although the cargo deployment system 10 is shown and described with a vehicle 12, module 14, and edge 16, the cargo deployment system 10 may have other configurations and arrangements including, but not limited to, a platform 18, that abuts the edge 16 and the curb 20. The edge 16 may partially define a cargo doorway of the vehicle for loading and unloading the modules 14.

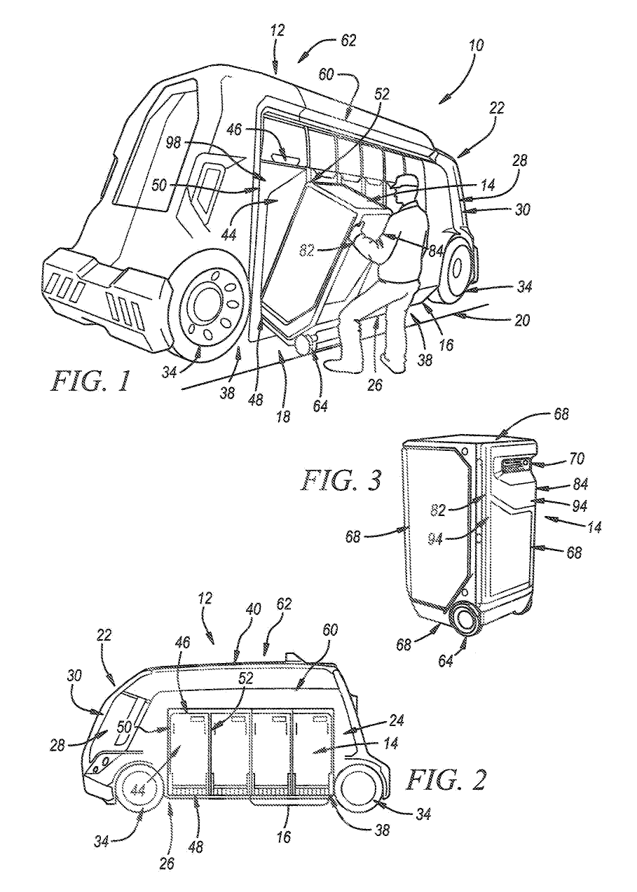

Referring to FIGS. 1-2, select variations of the cargo deployment system 10 may include a vehicle 12, and a module 14. The vehicle 12 may include a means of locomotion including vehicles such as, but not limited to, cars, buses, trains, planes, boats, or may be a different type. The vehicle may include locomotion means 34, which may include wheels or may move by another means. The vehicle 12 may include a cab 22, and a carrier 24 supported by chassis 26. It is to be understood that the suspension, brakes, fuel system, and other usual vehicle devices, mechanisms, and accessories, though not shown, may be included as required in the conventional state of the art in vehicle assembly. The cab 22 may be metallic with a rounded front 28 including a windshield 30 made of safety glass with rounded ends which extends traversely across the cab 22. A driver may operate the vehicle 12 from a driver's seat (not shown). Beneath the vehicle lies an engine (not shown) to power the vehicle 12 along its locomotion means 34. Coaxial with and adjoining the cab 22, the vehicle 12 may have a carrier 24 for transporting modules 14. The carrier may be made of sheet metal construction or may be polymeric material or another similarly functioning material. The carrier 24 may have two opposing longitudinal sides 60, 62 for transporting the modules. The carrier 24 may have a floor 38 which connects the two longitudinal sides 60, 62 as well as a roof 40 of the carrier 24. The carrier 24 may have a plurality of pods 44 extending across the length of the carrier 24 in the longitudinal direction parallel to a thoroughfare. These pods 44 may be used for transporting and housing modules 14. The pods 44 may have a top 46, a bottom 48, a first side 50, and a second side 52. The pods may ingress into the carrier 24 of the vehicle 12. The pod bottom 48 serves as a measuring point for the height of a curb on the thoroughfare that the vehicle 12 uses. The pod bottom 48 may be the height of the curb of the thoroughfare within 2 inches or less to ease ingress and egress of the modules into the pods 44 in the carrier 24. Along the longitudinal length of the vehicle 12, the pod bottoms 48 may form an edge 16, which may be within 2 inches of the height of the curb 20 on the thoroughfare. In one variation the edge 16 may be located at a distance ranging from 4-8 inches from a lower resting surface where the thoroughfare contacts the vehicle 12 or locomotion means 34, which may include a wheel, or 4-8 inches from the ground or thoroughfare on which the vehicle rests. In a number of variations the edge 16 may not be movable and may be fixed relative to the vehicle, for example, fixed with respect to the chassis 26 or carrier 24. In other variables the edge 16 may be movable. The vehicle 14 may also include a platform 18 that can be moved manually or automatically via the vehicle 12 power system to provide a surface between the edge 16 and the curb 20. The vehicle 12 or module 14 may include a display panel 70. The display panel 70 may display information. The information may include cargo tracking information, destination area, zip code, or cargo recipient address or a bar code or other code having such information which may be read and translated by an electronic code reader. The information may be preloaded onto the display panel 70 manually or electronically. The vehicle 12 may have an attachment 98 to attach the module 14 to the vehicle 12 in the pod 44. The attachment 98 may be may be a clip, tongue and groove, screw, nail, joint, or may be another type. The attachment 98 may be made of a polymeric material, fibrous material, textile material or metallic material and/or other similarly functioning materials.

Referring to FIG. 3, the module 14 may be any shape and also may include wheels 64 or may move by another means. In one variation a pair of wheels 64 may be provided near one side 68 of the module 14 and in another variation may be provided near opposite sides 68 of the module 14. The module 14 may be used for storing cargo. The module 14 may be made of polymeric material or metallic material and/or other similarly functioning materials. The module 14 may have a plurality of sides 68. The module 14 may include a display panel 70. The display panel 70 may display information. The information may include cargo tracking information, destination area, zip code, or cargo recipient address or a bar code or other code having such information which may be read and translated by an electronic code reader. The information may be preloaded onto the display panel 70 manually or electronically. The module may have side handles 82, 84 for grasping and moving the module manually. The module 14 may also move via an electronic remote control system for delivery. The module 14 may include a side 68 that opens and closes for insertion or withdrawal of the cargo. The module 14 may have an attachment 94 to attach the module 14 to the vehicle 12 in the pod 44. The attachment 94 may be may be a clip, tongue and groove, screw, nail, joint, or may be another type. The attachment 94 may be made of a polymeric material, fibrous material, textile material or metallic material and/or other similarly functioning materials.

In another variation a method is introduced which includes loading a module 14 for delivery to a location into a vehicle 12 through an edge 16 on the side of a vehicle 12 that may be at or within 2 inches of the height of a curb on a thoroughfare. The method may further include moving the module 14 into a pod 44 of the vehicle 12 by moving the module 14 from the curb of a thoroughfare into the vehicle pod 44 via the module wheel 64 or through another means of locomotion. The module 14 may be moved into the pod via manual grasping of the side handles 82, 84. The module 14 may then be held in place in the pod 44 within the vehicle 12 via the attachment on the vehicle 98 or the attachment on the module 94 or both. A platform 18 may aid in moving the module 14 from the curb on the thoroughfare into the vehicle pod 44 of the vehicle 12. The loading of the module 12 may be done manually or through electronic or mechanical means. The vehicle 12 and module 14 may then move closer to the location via locomotion of the vehicle 12. The module may then be un-loaded for delivery to a location out of a vehicle 12 from the vehicle pod 44 through an edge 16 on the side of a vehicle 12 that may be at or within 2 inches of the height of a curb on a thoroughfare. The module 14 may then be unloaded from the vehicle pod 44 by un-attaching the module from the vehicle 12 and more specifically the vehicle pod 44 by undoing the attachment on the vehicle 98 or the attachment on the module 94 or both. The method may further include un-loading the module 14 from a pod 44 of the vehicle 12 by moving the module 14 from the vehicle pod 44 onto the curb of a thoroughfare via the module wheel 64 or through another means of locomotion. The module 14 may be moved from the pod via manual grasping of the side handles 82, 84. The un-loading of the module 12 may be done manually or through electronic or mechanical means. A platform 18 may aid in moving the module 14 from the vehicle pod 44 of the vehicle 12 to the curb on the thoroughfare. The module 14 with its cargo may then be delivered to the location.

The vehicle 12 or module 14 may include a display panel 70. The display panel 70 may display information. The information may include cargo tracking information, destination area, zip code, or cargo recipient address or a bar code or other code having such information which may be read and translated by an electronic code reader. The information may be preloaded onto the display panel 70 manually or electronically. The cargo may be presorted into the module 14 according to the location that may be its final destination via the information on the display panel. The modules 14 may be presorted at a distribution hub. All of the cargo within a module 14 may be presorted so that a module's cargo arrives at a particular destination, such as an individual mailroom or skyscraper mailbox. The display panel 70 may set a pre-determined location for the cargo inside the module 14 to go. The vehicle 12 may follow a route 100 for delivery of the cargo inside the module 14. The route 100 may be pre-determined along a thoroughfare. The vehicle 12 may stop along the route 100 for delivery of the module 14 that contains the cargo to the location the cargo may be meant for delivery to. There may be a plurality of modules 14 meant for a plurality of different locations. The locations may be bunched along the route so that at a thoroughfare, the modules 14 may be loaded and un-loaded manually, electronically, or mechanically at a plurality of unloading points 102 that would increase the efficiency of the delivery of the cargo inside the module to its location. The display panel may indicate which modules 14 are meant to be unloaded at which unloading points 102. The indication may be done visually or audibly or may be another type. The tracking numbers may track the cargo inside the module 14. The tracking numbers may be transferred to the location electronically, mechanically, or manually for seamless receipt of the cargo of the module 14 to its final destination. The use of unloading points 102 along pre-determined routes 100 may increase efficiency by allowed the driver of the vehicle 12 to stay in the vehicle 12 during loading and unloading of the modules 14. This may increase efficiency of deployment of the cargo to its location.

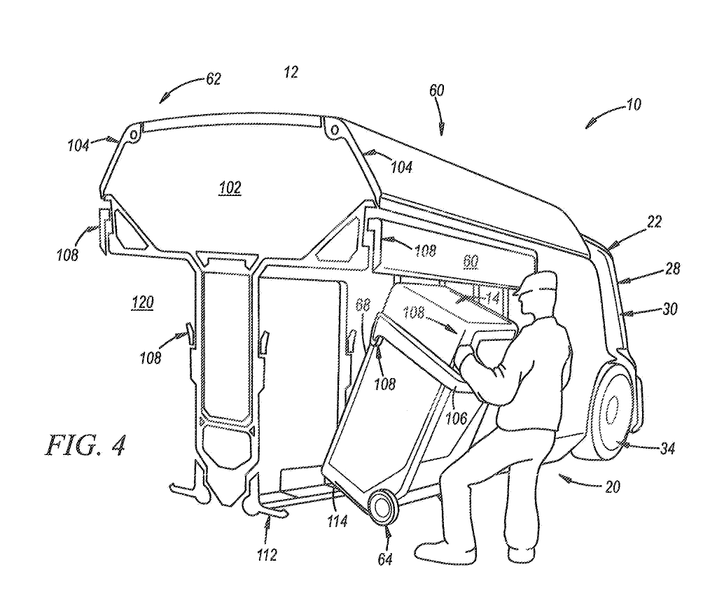

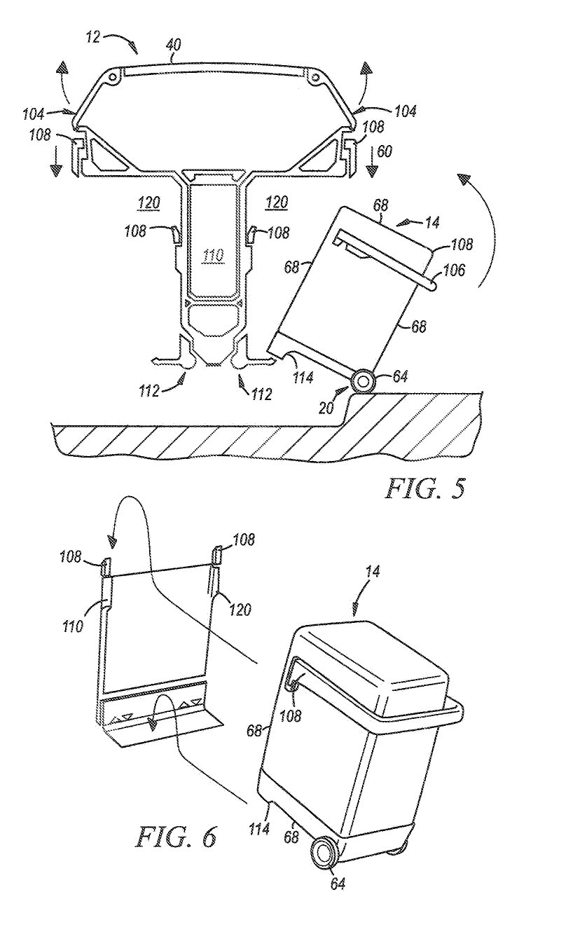

Referring to FIGS. 4-6, in another variation, there may be an empty cavity 120 for attachment of the module 14 into the vehicle 12 from the curb 20. The cavity 120 may run along both longitudinal sides 60, 62 of the carrier 24. In another variation the vehicle 12 may have an upper deck 102 for cargo, modules 12, or other items. The upper deck 102 may be found above the cab 22 or carrier 24 of the vehicle 12 or both or may be in another place. This upper deck 102 may be accessible from a plurality of access doors 104 placed along the roof 40, front 28, or longitudinal sides 60, 62 of the vehicle 12. The vehicle 12 may have a central frame 110 that runs along the central longitudinal axis of the carrier 24. The central frame 110 may contain a battery package, engine, or structure for propulsion of the vehicle 12 or may be used for alternative storage, or may be hollow. The vehicle 12 may have a plurality of attachment tabs 108 for attachment of a module 14 in the cavity 120. These attachment tabs 108 may function to attach the module 14 to the vehicle 12 in the cavity 120. These attachment tabs 108 may keep the modules 14 suspended from the vehicle 12 while the vehicle 12 is at rest or in motion. The suspended modules may provide an elevated structure and eliminate a traditional load floor for the vehicle. The suspended modules may further provide increased protection of the module cargo from the elements. The attachment tabs 108 may be a clip, tongue and groove, screw, nail, joint, or may be another type. The attachment tabs 108 may be made of a polymeric material, fibrous material, textile material or metallic material and/or other similarly functioning materials. A bottom tab 112 may be used to support or suspend the module 14 while the vehicle 12 is at rest or in motion. The bottom tab 112 may be at or within 2 inches in height from the top of the curb 20. The bottom tab 112 may be spring loaded to provide movement in the vertical direction with respect to the vehicle 12 for easier loading and unloading of the modules 14. The bottom tab 112 may be moved electronically, mechanically, or manually.

A module 14 may contain a handle bar 106 for movement, as well as attachment to the vehicle 12. The handle bar may be located anywhere on the module 14. The handle bar 106 may be made of metal or may be polymeric material or another similarly functioning material. The module 14 may contain a plurality of attachment tabs 108 for attachment of a module 14 to the vehicle 12 in the cavity 120 or elsewhere on the vehicle 12. The attachment tabs 108 may be on the module 14 or handle bar 106 or both. The attachment tabs 108 may be may be a clip, tongue and groove, screw, nail, joint, or may be another type. The attachment tabs 108 may be made of a polymeric material, fibrous material, textile material or metallic material and/or other similarly functioning materials. A module side 68 may also contain a bottom leg 114 for contacting the bottom tab 112 of the vehicle 12 or may rest on the ground when the module is at rest. The module may be lifted onto its locomotion means or wheels 64 when moving the module by tipping the module back on its locomotion means via the handle bar 106. In this way, the module 14 may function as a dolly for movement of the cargo, where at rest, the bottom leg 114 may be on the same horizontal plane as the locomotion means or wheels 64, which may allow the module to sit upright on a surface.

When the module 14 may be loaded into the vehicle 12, the module 14 may roll off the curb by using its locomotion means or wheels 64 as a fulcrum. This may lift the bottom leg 114 into the air and onto the bottom tap 112 of the vehicle or may aid in attaching the module 14 to the vehicle 12 in a different way. The module 14 may then be lifted and attached to vehicle through attachment of the attachment tabs 108 of the module 14 to the attachment tabs 108 of the vehicle 12 or may be attached in a different fashion. A primary attachment tab 116 of the vehicle 12 may be used to be the primary engagement of the module 14 on the vehicle central frame 110 or there may be a plurality of tabs with which to primarily engage the module 14 to the vehicle 12. A primary attachment tab 116 may be may be a clip, tongue and groove, screw, nail, joint, or may be another type. A primary attachment tab 116 may be made of a polymeric material, fibrous material, textile material or metallic material and/or other similarly functioning materials. The vehicle 14 may also include a platform 18 that can be moved manually or automatically via the vehicle 12 power system to provide a surface between the bottom leg 114 or bottom tab 112 and the curb 20. When suspended from the vehicle 12, the bottom leg 114 may be at or within 2 inches in height from the top of the curb 20 or may be as much as 5 inches in height from the top of the curb. When suspended from the vehicle 12, the module 14 may be exposed to air on one or more sides. In unloading, the attachments 108 may be unattached between the module 14 and the vehicle 12, and the module may be tipped backward on its locomotion means or wheels 64 and rolled backward away from the vehicle onto the curb 20 or may be unloaded by other means. The module may be lowered onto the curb via the platform 18 or may be lowered by other means. This method would allow for faster and more efficient delivery of the modules 14 and their cargo to the locations. The modules 14 may be unloaded manually or electronically or mechanically.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a system for deployment of cargo including at least one module for containment and delivery of cargo to a location and a vehicle for thoroughfare delivery of the module further including an edge at or within 2 inches of the height of a curb on a thoroughfare for deployment of the module onto the curb.

Variation 2 may include a system as set forth in Variation 1 further including a display panel displaying information on the location wherein the information includes at least one of cargo tracking information, destination area, zip code, or cargo recipient address or a bar code or other code having such information which may be read and translated by an electronic code reader.

Variation 3 may include a system as set forth in any of Variations 1-2 wherein the module has at least one wheel.

Variation 4 may include a system as set forth in Variation 2 wherein the display panel may be located on the module.

Variation 5 may include a system as set forth in any of Variations 1-4 wherein the module or edge may be located on a longitudinal side of the vehicle.

Variation 6 may include a system as set forth in any of Variations 1-5 wherein the location may be pre-determined.

Variation 7 may include a system as set forth in any of Variations 1-6 wherein the wherein the cargo may be presorted to arrive at the location on the display panel.

Variation 8 may include a system as set forth in any of Variations 1-7 wherein the vehicle further comprises an adjustable panel that moves between the vehicle edge and curb.

Variation 9 may include a product including a cargo delivery system including a vehicle wherein the vehicle includes an edge at or within 2 inches of the height of a curb on a thoroughfare.

Variation 10 may include a product as set forth in Variations 9 further including a module wherein the module has at least one wheel.

Variation 11 may include a product as set forth in any of Variations 9-10 further including a display panel displaying information on the location wherein the information includes at least one of cargo tracking information, destination area, zip code, or cargo recipient address or a bar code or other code having such information which may be read and translated by an electronic code reader.

Variation 12 may include a product as set forth in any of Variations 9-11 wherein the display panel may be located on the module.

Variation 13 may include a product as set forth in any of Variations 9-12 wherein the module or edge may be located on a longitudinal side of the vehicle.

Variation 14 may include a product as set forth in any of Variations 9-13 wherein the vehicle further comprises an adjustable panel that moves between the vehicle edge and curb.

Variation 15 may include a product as set forth in any of Variations 9-14 wherein the cargo may be presorted to arrive at the location on the module.

Variation 16 may include a method including loading at least one module for delivery to a location into a vehicle through an edge on the side of a vehicle that may be at or within 2 inches of the height of a curb on a thoroughfare, moving the vehicle closer to the location, un-loading the module from the vehicle through the edge on the side of the vehicle that may be at or within 2 inches of the height of a curb on a thoroughfare, and delivery the module to the location.

Variation 17 may include a method as set forth in Variation 16 including providing a display panel displaying information on the location wherein the information includes at least one of cargo tracking information, destination area, zip code, or cargo recipient address or a bar code or other code having such information which may be read and translated by an electronic code reader.

Variation 18 may include a method as set forth in any of Variations 16-17 including loading or unloading the module along a pre-determined route.

Variation 19 may include a method as set forth in any of Variations 16-18 wherein the un-loading and loading of the module may be done manually, mechanically, or electronically.

Variation 20 may include a method as set forth in any of Variations 16-19 wherein the display panel indicates where the module may be loaded or unloaded along the predetermined route.

Variation 21 may include a product as set forth in any of Variations 9-15 wherein the vehicle has at least one pod that ingresses into the vehicle.

Variation 22 may include a product as set forth in any of Variations 9-15 and 21 wherein the vehicle or the module has an attachment to attach the module to the vehicle.

Variation 23 may include a product as set forth in any of Variations 11-15 and 21-22 wherein the information may be preloaded into the display panel.

Variation 24 may include a product as set forth in any of Variations 16-19 wherein module may be delivered via a remote control system.

Variation 25 may include a method as set forth in any of Variations 17-20 wherein display panel indicates audibly or visually when a module should be unloaded from the vehicle for delivery of the cargo.

Variation 26 may include a product as set forth in any of Variations 9-15 and 21-25 wherein the edge may be within 3 inches of the height of the curb on the thoroughfare.

Variation 27 may include a system as set forth in any of Variations 1-8 wherein the edge may be within 3 inches of the height of the curb on the thoroughfare.

Variation 28 may include a method as set forth in any of Variations 16-20 and 25 wherein the edge may be within 3 inches of the height of the curb on the thoroughfare.

Variation 29 may include a system for deployment of cargo including at least one module for containment and delivery of cargo to a location and a vehicle for thoroughfare delivery of the module further including at least one attachment wherein the module is suspended inside a cavity of the vehicle with the attachment; and wherein a module side is at or within 2 inches of the height of a curb on a thoroughfare for deployment of the module onto the curb.

Variation 30 may include a system as set forth in Variation 29 further including a display panel displaying information on the location wherein the information includes at least one of cargo tracking information, destination area, zip code, or cargo recipient address or a bar code or other code having such information which may be read and translated by an electronic code reader.

Variation 31 may include a system as set forth in any of Variations 29-30 wherein the module has at least one wheel.

Variation 32 may include a system as set forth in Variation 29-31 wherein the display panel may be located on the module.

Variation 33 may include a system as set forth in any of Variations 29-32 wherein the module may be located on a longitudinal side of the vehicle.

Variation 34 may include a system as set forth in any of Variations 29-33 the wherein the location may be pre-determined.

Variation 35 may include a system as set forth in any of Variations 29-34 wherein the wherein the cargo may be presorted to arrive at the location on the display panel.

Variation 36 may include a system as set forth in any of Variations 29-35 wherein the vehicle further comprises an adjustable platform that moves between the vehicle cavity and curb.

Variation 37 may include a product including a cargo delivery system including a vehicle with a cavity wherein the vehicle further includes at least one attachment capable of suspending a module wherein a module side is at or within 2 inches of the height of a curb on a thoroughfare.

Variation 38 may include a product as set forth in Variation 37 wherein the module has at least one wheel.

Variation 39 may include a product as set forth in any of Variations 37-38 further including a display panel displaying information on the location wherein the information includes at least one of cargo tracking information, destination area, zip code, or cargo recipient address or a bar code or other code having such information which may be read and translated by an electronic code reader.

Variation 40 may include a product as set forth in any of Variations 37-39 wherein the display panel may be located on the module.

Variation 41 may include a product as set forth in any of Variations 37-40 wherein the module may be located on a longitudinal side of the vehicle.

Variation 42 may include a product as set forth in any of Variations 37-41 wherein the vehicle further comprises an adjustable platform that moves between the vehicle cavity and curb.

Variation 43 may include a product as set forth in any of Variations 37-42 wherein the cargo may be presorted to arrive at the location on the module.

Variation 44 may include a method including loading at least one module for delivery to a location into a vehicle through a cavity in the vehicle and suspending the module from at least one attachment wherein a module side is at or within 2 inches of the height of a curb on a thoroughfare, moving the vehicle closer to the location, un-loading the module from the vehicle through the cavity in the vehicle by undoing the attachment and moving the module onto the curb on a thoroughfare, and delivering the module to the location.

Variation 45 may include a method as set forth in Variation 44 including providing a display panel displaying information on the location wherein the information includes at least one of cargo tracking information, destination area, zip code, or cargo recipient address or a bar code or other code having such information which may be read and translated by an electronic code reader.

Variation 46 may include a method as set forth in any of Variations 44-45 including loading or unloading the module along a pre-determined route.

Variation 47 may include a method as set forth in any of Variations 44-46 wherein the un-loading and loading of the module may be done manually, mechanically, or electronically.

Variation 48 may include a method as set forth in any of Variations 44-47 wherein the display panel indicates where the module may be loaded or unloaded along the predetermined route.

Variation 51 may include a product as set forth in any of Variations 37-43 wherein the information may be preloaded into the display panel.

Variation 52 may include a product as set forth in any of Variations 37-43 wherein module may be delivered via a remote control system.

Variation 53 may include a method as set forth in any of Variations 44-48 wherein display panel indicates audibly or visually when a module should be unloaded from the vehicle for delivery of the cargo.

Variation 54 may include a product as set forth in any of Variations 37-43 wherein the module side may be within 3 inches of the height of the curb on the thoroughfare.

Variation 55 may include a system as set forth in any of Variations 29-36 wherein the module side may be within 3 inches of the height of the curb on the thoroughfare.

Variation 56 may include a method as set forth in any of Variations 44-48 wherein the module side may be within 3 inches of the height of the curb on the thoroughfare.

The above description of select examples of the invention is merely exemplary in nature and, thus, variations or variants thereof are not to be regarded as a departure from the spirit and scope of the invention.

1. A system for deployment of cargo comprising:
at least one module for containment and delivery of cargo to a location;
a vehicle for thoroughfare delivery of the module further comprising at least one attachment wherein the module is suspended inside a cavity of the vehicle with the attachment; wherein a module side is at or within 2 inches of the height of a curb on a thoroughfare for deployment of the module onto the curb.

2. The system of claim 1 further comprising a display panel displaying information on the location wherein the information includes at least one of cargo tracking information, destination area, zip code, cargo recipient address, or a bar code or other code having such information which may be read and translated by an electronic code reader.

3. The system of claim 1 wherein the module has at least one wheel.

4. The system of claim 2 wherein the display panel is located on the module.

5. The system of claim 1 wherein the module is located on a longitudinal side of the vehicle.

6. The system of claim 1 wherein the location is pre-determined.

7. The system of claim 2 wherein the cargo is presorted into modules to arrive at the location on the display panel.

8. The system of claim 1 wherein the vehicle further comprises an adjustable platform that moves between the vehicle cavity and curb.

9. A product comprising:
a cargo delivery system comprising a vehicle comprising a cavity and at least one attachment wherein the attachment is capable of suspending a module wherein a module side is at or within 2 inches of the height of a curb on a thoroughfare.

10. The product of claim 9 wherein the module has at least one wheel.

11. The product of claim 9 further comprising a display panel displaying information on the location wherein the information includes at least one of cargo tracking information, destination area, zip code, cargo recipient address, or a bar code or other code having such information which may be read and translated by an electronic code reader.

12. The product of claim 10 wherein the display panel is located on the module.

13. The product of claim 9 wherein the module is located on a longitudinal side of the vehicle.

14. The product of claim 9 wherein the vehicle further comprises an adjustable platform that moves between the vehicle cavity and curb.

15. The product of claim 9 wherein the cargo is presorted to arrive at the location on the display panel.

16. A method comprising:
loading at least one module for delivery to a location into a vehicle through a cavity in the vehicle and suspending the module from at least one attachment wherein a module side is at or within 2 inches of the height of a curb on a thoroughfare;
moving the vehicle closer to the location;
un-loading the module from the vehicle through the cavity in the vehicle by undoing the attachment and moving the module onto the curb on a thoroughfare; and
delivering the module to the location.

17. The method of claim 16 further comprising providing a display panel
displaying information on the location wherein the information includes at least one of cargo tracking information, destination area, zip code, cargo recipient address, or a bar code or other code having such information which may be read and translated by an electronic code reader.

18. The method of claim 16 further comprising loading or unloading the module along a pre-determined route.

19. The method of claim 16 wherein the un-loading and loading of the module is done manually, mechanically, or electronically.

20. The method of claim 16 wherein the display panel indicates where the module is to be loaded or unloaded along the predetermined route.
